(19) United States
(12) Patent Application Publication
(10) Pub. No.: US 2025/0381636 A1
(43) Pub. Date: Dec. 18, 2025

(54) QUALITY PREDICTION AND ADAPTIVE COMPENSATION METHOD AND APPARATUS FOR CURVED SURFACE ASSEMBLY

(71) Applicant: Ningbo University, Ningbo (CN)

(72) Inventors: Sitong XIANG, Ningbo (CN); Hainan ZHANG, Ningbo (CN); Jingwen LAO, Ningbo (CN); Nong LI, Ningbo (CN); Kejian CHEN, Ningbo (CN); Cheng WU, Ningbo (CN)

(73) Assignee: Ningbo University, Ningbo (CN)

(21) Appl. No.: 19/313,935

(22) Filed: Aug. 29, 2025

Related U.S. Application Data
(63) Continuation of application No. PCT/CN2023/081828, filed on Mar. 16, 2023.

(30) Foreign Application Priority Data
Mar. 2, 2023 (CN) 202310190166.3

(51) Int. Cl. B23Q 15/12; B23Q 23/00; G01B 11/24; G06T 7/00; G06T 7/73

(52) U.S. Cl. CPC B23Q 15/12; B23Q 23/00; G01B 11/24; G06T 7/0014; G06T 7/74; G06T 2207/10028; G06T 2207/30164

(57) ABSTRACT

A quality prediction and adaptive compensation method and apparatus for curved surface assembly are provided. The method includes: inputting a geometric error function and a thermal error function into a spatial error model, to obtain a machining error prediction model; superimposing obtained machining errors on a theoretical surface of an assembly surface, to obtain a predicted machining surface; calculating, according to an assembly median plane determined based on the assembly surface, shape errors and assembly gap errors, and predicting curved surface assembly quality of a part by using the shape errors and the assembly gap errors; calculating an adaptive compensation amount of each assembly plane of the assembly surface based on the shape errors, the assembly gap errors, and the machining errors, when the curved surface assembly quality does not meet a preset assembly quality requirement, and compensating the corresponding assembly plane by using the adaptive compensation amount.

### CROSS REFERENCE TO THE RELATED APPLICATIONS

This application is a continuation application of International Application No. PCT/CN2023/081828, filed on Mar. 16, 2023, which is based upon and claims priority to Chinese Patent Application No. 202310190166.3, filed on Mar. 2, 2023, the entire contents of which are incorporated herein by reference.

### TECHNICAL FIELD

The present application relates to the technical field of precision machining of computer numerical control machine tools, and in particular, to a quality prediction and adaptive compensation method and apparatus for curved surface assembly.

### BACKGROUND

As electromechanical products such as satellites, rockets and airplanes develop toward complexity, light weight, and precision, their assembly precision requirements and assembly difficulty are increasing day by day, and it is also increasingly difficult to ensure product assembly performance. In such electromechanical products, a large number of key components are of complex curved surfaces, and assembly quality of these complex curved surface parts will have a significant impact on product performance.

To implement high-quality assembly of complex curved surface parts, not only a very high geometric precision is required for the complex curved surface parts, but also high assembly precision and good assembly performance are required for the plurality of complex curved surface parts. Complex curved surface parts are usually machined by a five-axis computer numerical control machine tool, and assembly errors are mainly generated by cumulative coupling of machining errors of the parts. Geometric and thermal errors of the five-axis computer numerical control machine tool account for 50%-70% of total machine tool errors, which are important factors affecting the machining precision of complex curved surfaces. Assembly is one of the last steps in product manufacturing, and assembly quality determines the final quality of products to a great extent. However, existing methods for improving assembly quality only focus on a matching gap, ignores shape errors between curved surfaces, and cannot ensure the assembly quality of final products.

### SUMMARY

In view of this, embodiments of the present application provide a quality prediction and adaptive compensation method and apparatus for curved surface assembly, which evaluate curved surface assembly quality from two aspects: shape error and assembly gap error, and then calculate an optimal compensation amount of each assembly plane based on the two aspects, so as to ensure product assembly quality.

To implement the above-mentioned objective, according to an aspect of the present application, a quality prediction and adaptive compensation method for curved surface assembly is provided.

The quality prediction and adaptive compensation method for curved surface assembly quality provided by an embodiment of the present application includes: establishing a spatial error model of a machine tool; fitting measured real geometric error data of the machine tool to form a geometric error function; fitting measured real thermal error data of the machine tool to form a thermal error function; inputting the geometric error function and the thermal error function into the spatial error model, to obtain a machining error prediction model of the machine tool; obtaining machining errors of an assembly surface of a part by using the machining error prediction model, and superimposing the obtained machining errors on a theoretical plane of the assembly surface, to obtain a predicted machining surface; determining an initial assembly position of the predicted machining surface, and optimizing a relative position between curved surfaces of the predicted machining surface based on predetermined curved surface information of the assembly surface, to implement assembly positioning of the part; calculating, according to an assembly median plane determined based on the assembly surface, shape errors and assembly gap errors of the assembly surface for the part whose assembly positioning is implemented, and predicting curved surface assembly quality of the part by using the shape errors and the assembly gap errors; and calculating an adaptive compensation amount of each assembly plane of the assembly surface based on the shape errors, the assembly gap errors, and the machining errors, when the curved surface assembly quality does not meet a preset assembly quality requirement, and compensate the corresponding assembly plane by using the adaptive compensation amount.

Optionally, the fitting measured real thermal error data of the machine tool to form a thermal error function includes: fitting geometric data in the real thermal error data into a polynomial function with a coordinate value as an independent variable, fitting thermal data in the real thermal error data into a time-varying slope function with temperature as an independent variable, and superimposing the polynomial function and the time-varying slope function to form the thermal error function.

Optionally, the method further includes: obtaining assembly constraint information of a real assembly scenario after the obtaining a predicted machining surface, converting the assembly constraint information into geometric information in the form of a transition matrix, and combining the geometric information with the predicted machining surface, to constrain the predicted machining surface.

Optionally, the calculating the shape errors includes: performing an averaging operation on two assembly planes of the assembly surface to obtain the assembly median plane, discretizing the assembly median plane and the two assembly planes to form a plurality of point cloud coordinates, and normalizing the point cloud coordinates; matching the point cloud coordinates of the assembly median plane and the two assembly planes by using an Earth mover's distance; and determining, after the matching is completed, minimum values of sums of Euclidean distances between the points on the assembly median plane and corresponding points on the two assembly planes as the shape errors.

Optionally, the calculating the assembly gap errors includes: performing an averaging operation on two assembly planes of the assembly surface to obtain the assembly median plane, discretizing the assembly median plane and the two assembly planes to form a plurality of point cloud coordinates, and normalizing the point cloud coordinates; matching the point cloud coordinates of the assembly median plane and the two assembly planes by using an Earth mover's distance; and determining, after the matching is completed, root mean square errors of coordinates of the points on the assembly median plane and corresponding points on the two assembly planes as the assembly gap errors.

Optionally, the assembly planes include a first-processing assembly plane and a second-processing assembly plane, and an adaptive compensation amount Δa of the first-processing assembly plane is calculated according to the following formula:

$${A}_{0} + {a}_{0} + Δ a = ( {B}_{0} + {b}_{0} ) \cdot M$$

where A₀ represents coordinate data of the first-processing assembly plane, B₀ represents coordinate data of the second-processing assembly plane, a₀ represents machining errors between the first-processing assembly plane and a corresponding theoretical plane, b₀ represents machining errors between the second-processing assembly plane and a corresponding theoretical plane, and M represents a transition matrix from a coordinate system of the second-processing assembly plane to a coordinate system of the first-processing assembly plane. The method further includes: determining, after the first-processing assembly plane is compensated by using the adaptive compensation amount Δa, whether the compensated first-processing assembly plane meets a first constraint condition determined based on the shape error: if yes, performing a machining operation; and otherwise, setting b₀ of a point that does not meet the first constraint condition to zero, and then recalculating the adaptive compensation amount Δa, until the compensated first-processing assembly plane meets the first constraint condition, where the first constraint condition is a tolerance zone added to the assembly median plane according to the shape errors.

Optionally, the adaptive compensation amount Δb of the second-processing assembly plane is calculated according to the following formula:

$${B}_{0} + {b}_{0} + Δ b = {A}_{1} \cdot M$$

where A₁ represents coordinate data of the compensated first-processing assembly plane that meets the first constraint condition, and M₁ represents a transition matrix from a coordinate system of the first-processing assembly plane to a coordinate system of the second-processing assembly plane. The method further includes: determining, after the second-processing assembly plane is compensated by using the adaptive compensation amount Δb, whether the compensated second-processing assembly plane meets a second constraint condition determined based on the assembly gap error: if yes, performing a machining operation; and otherwise, recalculating the adaptive compensation amount Δb, until the compensated second-processing assembly plane meets the second constraint condition.

To implement the above-mentioned objective, according to another aspect of the present application, a quality prediction and adaptive compensation apparatus for curved surface assembly is provided.

The quality prediction and adaptive compensation apparatus for curved surface assembly provided by an embodiment of the present application may include: a modeling unit configured to establish a spatial error model of a machine tool, fit measured real geometric error data of the machine tool to form a geometric error function, fit measured real thermal error data of the machine tool to form a thermal error function, and input the geometric error function and the thermal error function into the spatial error model, to obtain a machining error prediction model of the machine tool; an assembly positioning unit configured to obtain machining errors of an assembly surface of a part by using the machining error prediction model, superimpose the obtained machining errors on a theoretical plane of the assembly surface, to obtain a predicted machining surface, determine an initial assembly position of the predicted machining surface, and optimize a relative position between curved surfaces of the predicted machining surface based on predetermined curved surface information of the assembly surface, to implement assembly positioning of the part; an assembly quality evaluation unit configured to calculate, according to an assembly median plane determined based on the assembly surface, shape errors and assembly gap errors of the assembly surface for the part whose assembly positioning is implemented, and predict curved surface assembly quality of the part by using the shape errors and the assembly gap errors; and an adaptive compensation unit configured to calculate an adaptive compensation amount of each assembly plane of the assembly surface based on the shape errors, the assembly gap errors, and the machining errors, when the curved surface assembly quality does not meet a preset assembly quality requirement, and compensate the corresponding assembly plane by using the adaptive compensation amount.

To implement the above-mentioned objective, according to still another aspect of the present application, an electronic device is provided.

The electronic device provided by the present application includes: one or more processors; and a storage apparatus configured to store one or more programs, where the one or more programs, when executed by the one or more processors, cause the one or more processors to implement a quality prediction and adaptive compensation method and apparatus for curved surface assembly provided by the present application.

To implement the above-mentioned objective, according to still another aspect of the present application, a computer-readable storage medium is provided.

The computer-readable storage medium provided by the present application has a computer program stored thereon, where the program, when executed by a processor, implements a quality prediction and adaptive compensation method for curved surface assembly provided by the present application.

According to the technical solutions of the present application, the embodiments of the present application have the following advantages or beneficial effects.

In the technical solutions of the embodiments of the present application, the spatial error model of the machine tool is first established, and the geometric error function and the thermal error function that are determined based on the real error data are input into the spatial error model to obtain the machining error prediction model of the machine tool. Then, the machining errors of the assembly surface of the part are obtained by using the machining error prediction model, and the obtained machining errors are superimposed on the theoretical plane of the assembly surface to obtain the predicted machining surface, and assembly positioning of the part is implemented by a coarse positioning step and a fine positioning step. Then, the assembly median plane of the assembly surface is determined, the shape errors and the assembly gap errors of the assembly surface are calculated, and the curved surface assembly quality of the part is predicted by using the calculated shape errors and assembly gap errors. When the curved surface assembly quality does not meet the assembly quality requirement, the adaptive compensation amount of each assembly plane is calculated based on the shape errors, the assembly gap errors, and the machining errors determined by the above-mentioned machining error prediction model, and finally, the corresponding assembly plane is compensated by using the calculated adaptive compensation amount. Through the above-mentioned steps, the curved surface assembly quality is comprehensively evaluated from two aspects: shape error and assembly gap error, and the adaptive compensation amount of each assembly plane is accurately calculated from the two aspects, thereby greatly improving assembly quality and assembly performance of products.

Further effects of the above-mentioned non-conventional optional methods will be described below in conjunction with specific implementations.

### BRIEF DESCRIPTION OF THE DRAWINGS

The accompanying drawings are used to better understand the present application, and do not constitute an undue limitation on the present application. In the drawings:

FIG. 1 is a schematic diagram of main steps of a quality prediction and adaptive compensation method for curved surface assembly according to an embodiment of the present application;

FIG. 2 is a schematic structural diagram of a five-axis computer numerical control machine tool according to an embodiment of the present application;

FIG. 3 is a schematic diagram of prediction of an assembly plane under the influence of geometric errors and thermal errors according to an embodiment of the present application;

FIG. 4 is a schematic diagram of coarse positioning and fine positioning in part positioning according to an embodiment of the present application;

FIG. 5 is a schematic diagram of product assembly precision and performance analysis under a shape error indicator and an assembly gap error indicator according to an embodiment of the present application;

FIG. 6 is a schematic diagram of coordinated adaptive compensation under the constraints of shape errors and assembly gap errors according to an embodiment of the present application;

FIGS. 7A-7C are schematic diagrams of predictions of shape errors and assembly gap errors of an assembly plane according to an embodiment of the present application;

FIG. 8 is a schematic diagram of coordinated adaptive compensation according to an embodiment of the present application;

FIG. 9 is a schematic diagram of constituent portions of a quality prediction and adaptive compensation apparatus for curved surface assembly according to an embodiment of the present application;

FIG. 10 is an architectural diagram of an exemplary system in which a quality prediction and adaptive compensation method and apparatus for curved surface assembly according to embodiments of the present application may be applied; and

FIG. 11 is a schematic structural diagram of an electronic device used to implement a quality prediction and adaptive compensation method for curved surface assembly according to an embodiment of the present application.

### DETAILED DESCRIPTION OF THE EMBODIMENTS

The following describes exemplary embodiments of the present application in conjunction with the accompanying drawings, including various details of the embodiments of the present application to facilitate understanding, which should be considered as merely exemplary. Therefore, those skilled in the art should realize that various changes and modifications may be made to the embodiments described herein without departing from the scope and spirit of the present application. Similarly, for the sake of clarity and conciseness, the description of well-known functions and structures is omitted in the following description.

It should be noted that the embodiments of the present application and the technical features therein may be combined with each other without conflict.

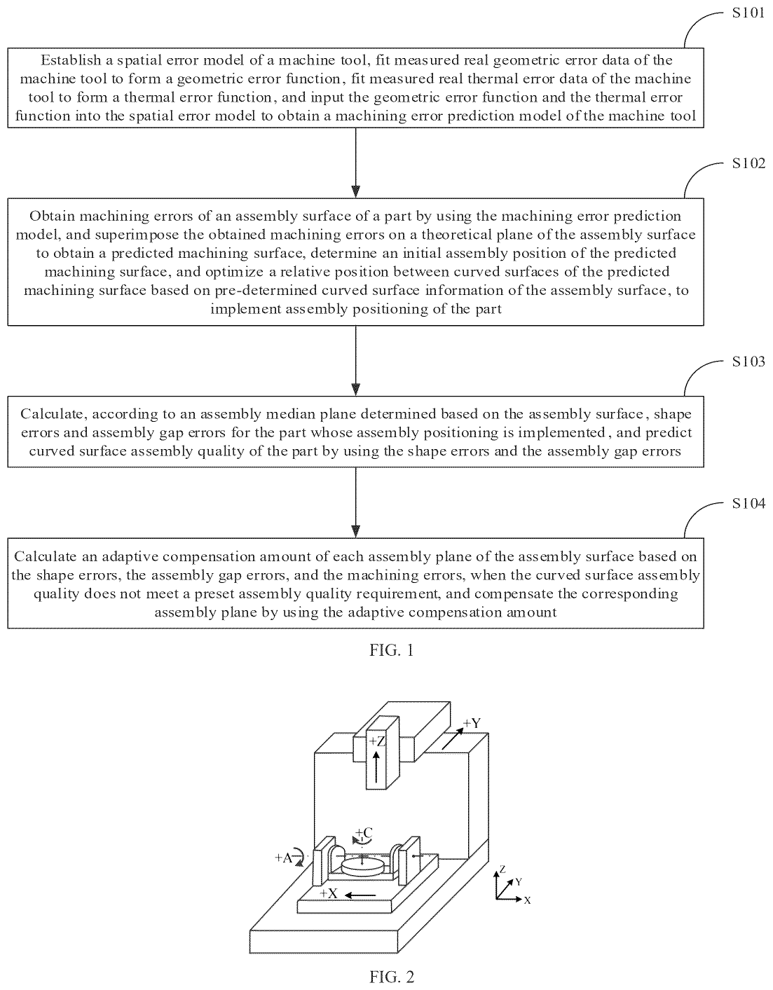

FIG. 1 is a schematic diagram of main steps of a quality prediction and adaptive compensation method for curved surface assembly according to an embodiment of the present application.

As shown in FIG. 1, the quality prediction and adaptive compensation method for curved surface assembly provided by this embodiment of the present application may be specifically performed according to the following steps.

Step S101: Establish a spatial error model of a machine tool, fit measured real geometric error data of the machine tool to form a geometric error function, fit measured real thermal error data of the machine tool to form a thermal error function, and input the geometric error function and the thermal error function into the spatial error model to obtain a machining error prediction model of the machine tool.

For example, the above-mentioned machine tool is a five-axis computer numerical control machine tool. In this step, the spatial error model that contains spatial position errors and direction errors may be established in advance, and the geometric error function and the thermal error function are obtained by fitting the error data. Optionally, geometric data in the real thermal error data may be fitted into a polynomial function with a coordinate value as an independent variable, thermal data in the real thermal error data may be fitted into a time-varying slope function with temperature as an independent variable, and the polynomial function and the time-varying slope function are superimposed to form the thermal error function.

Step S102: Obtain machining errors of an assembly surface of a part by using the machining error prediction model, and superimpose the obtained machining errors on a theoretical plane of the assembly surface to obtain a predicted machining surface, determine an initial assembly position of the predicted machining surface, and optimize a relative position between curved surfaces of the predicted machining surface based on pre-determined curved surface information of the assembly surface, to implement assembly positioning of the part.

An objective of this step is to simulate a real assembly state to implement assembly positioning of the part. Specifically, the machining errors of the assembly surface are first calculated by using the machining error prediction model determined in step S101, and then the machining errors are superimposed on the theoretical plane of the assembly surface, thereby obtaining the predicted machining surface. As a preferred solution, thereafter, assembly constraint information of a real assembly scenario may be obtained, the assembly constraint information is converted into geometric information in the form of a transition matrix, and the geometric information is combined with the predicted machining surface, to constrain the predicted machining surface. Finally, a two-step positioning method including coarse positioning and fine positioning proposed by this embodiment of the present application may be used to implement assembly positioning. Specifically, in a coarse positioning step, the initial assembly position of the predicted machining surface is first determined. In a fine positioning step, the relative position between the curved surfaces of the predicted machining surface is optimized based on pre-determined curved surface information of the assembly surface, thereby implementing assembly positioning of the part.

Step S103: Calculate, according to an assembly median plane determined based on the assembly surface, shape errors and assembly gap errors for the part whose assembly positioning is implemented, and predict curved surface assembly quality of the part by using the shape errors and the assembly gap errors.

In this step, concepts of the shape error and the assembly gap error are proposed. Shape error refers to an error formed from a degree of difference between two-dimensional shapes of assembly curved surfaces, and assembly gap error refers to a distance error formed from the prospective of an assembly gap. In actual application, the shape errors may be calculated through the following steps: first, performing an averaging operation on two assembly planes of the assembly surface to obtain the assembly median plane, discretizing the assembly median plane and the two assembly planes to form a plurality of point cloud coordinates, and normalizing the point cloud coordinates; then, matching the point cloud coordinates of the assembly median plane and the two assembly planes by using an Earth mover's distance; and determining, after the matching is completed, minimum values of sums of Euclidean distances between the points on the assembly median plane and corresponding points on the two assembly planes as the shape errors.

In specific application, the assembly gap errors may be calculated through the following steps: first, performing an averaging operation on two assembly planes of the assembly surface to obtain the assembly median plane, discretizing the assembly median plane and the two assembly planes to form a plurality of point cloud coordinates, and normalizing the point cloud coordinates; matching the point cloud coordinates of the assembly median plane and the two assembly planes by using an Earth mover's distance; and determining, after the matching is completed, root mean square errors of coordinates of the points on the assembly median plane and corresponding points on the two assembly planes as the assembly gap errors.

Step S104: Calculate an adaptive compensation amount of each assembly plane of the assembly surface based on the shape errors, the assembly gap errors, and the machining errors, when the curved surface assembly quality does not meet a preset assembly quality requirement, and compensate the corresponding assembly plane by using the adaptive compensation amount.

In this step, the compensation amount of each assembly plane may be calculated for the case of unqualified assembly quality, thereby improving assembly quality. Specifically, the above-mentioned assembly planes may include a first-processing assembly plane and a second-processing assembly plane. The adaptive compensation amount Δa of the first-processing assembly plane may be calculated according to the following formula:

$${A}_{0} + {a}_{0} + Δ a = ( {B}_{0} + {b}_{0} ) \cdot M$$

where A₀ represents coordinate data of the first-processing assembly plane, B₀ represents coordinate data of the second-processing assembly plane, a₀, represents machining errors between a first-processing assembly plane and a corresponding theoretical plane, b₀ represents machining errors between a second-processing assembly plane and a corresponding theoretical plane, and M represents a transition matrix from a coordinate system of the second-processing assembly plane to a coordinate system of the first-processing assembly plane.

Preferably, after the first-processing assembly plane is compensated by using the adaptive compensation amount Δa, it may be determined whether the compensated first-processing assembly plane meets a first constraint condition that is determined based on the shape errors. For example, the first constraint condition may be a tolerance zone added to the assembly median plane according to the shape errors. When the compensated first-processing assembly plane meets the first constraint condition, a machining operation is performed; and otherwise, b₀ of a point that does not meet the first constraint condition may be set to zero and then the adaptive compensation amount Δa is recalculated, until the compensated first-processing assembly plane meets the first constraint condition.

In an optional technical solution, the adaptive compensation amount Δb of the second-processing assembly plane may be calculated according to the following formula:

$${B}_{0} + {b}_{0} + Δ b = {A}_{1} \cdot M$$

where A₁ represents coordinate data of the compensated first-processing assembly plane that meets the first constraint condition, and M′ represents a transition matrix from a coordinate system of the first-processing assembly plane to a coordinate system of the second-processing assembly plane.

Similarly, after the second-processing assembly plane is compensated by using the adaptive compensation amount Δb, it may be determined whether the compensated second-processing assembly plane meets a second constraint condition that is determined based on the assembly gap error: if yes, a machining operation is performed; and otherwise, the adaptive compensation amount Δb is recalculated, until the compensated second-processing assembly plane meets the second constraint condition.

The following describes a specific embodiment of the present application.

Specific steps of this embodiment are as follows.

Step 1: Prediction of size errors of a complex curved surface under the influence of geometric errors and thermal errors of a five-axis computer numerical control machine tool. The five-axis computer numerical control machine tool has 41 geometric errors in total which are 21 geometric errors for three translational axes, and 8 position-independent geometric errors (PIGEs) and 12 position-dependent geometric errors (PDGEs) for two rotational axes. Here, an XACRYZ five-axis computer numerical control machine tool is used as an example, and the definition of ISO 230-1 is used. The 41 geometric errors are shown in the following table.

| | PDGEs | PIGEs |
|---|---|---|
| X axis | E_{XX}, E_{YX}, E_{ZX}, E_{AX}, E_{BX}, E_{CX} | |
| Y axis | E_{XY}, E_{YY}, E_{ZY}, E_{AY}, E_{BY}, E_{CY} | E_{COY}, E_{AOZ}, E_{BOZ} |
| Z axis | E_{XZ}, E_{YZ}, E_{ZZ}, E_{AZ}, E_{BZ}, E_{CZ} | |
| A axis | E_{XA}, E_{YA}, E_{ZA}, E_{AA}, E_{BA}, E_{CA} | E_{YOA}, E_{ZOA}, E_{XOC}, E_{YOC} |
| C axis | E_{XC}, E_{YC}, E_{ZC}, E_{AC}, E_{BC}, E_{CC} | E_{BOA}, E_{COA}, E_{AOC}, E_{BOC} |

A kinematic chain structure of the five-axis computer numerical control machine tool is shown in FIG. 2, where the X axis, A axis, and C axis belong to a workpiece kinematic chain, and the Y axis and the Z axis belong to a tool kinematic chain. A spatial error model of the five-axis computer numerical control machine tool may be established based on a homogeneous coordinate transition matrix method, where spatial position errors ΔP and direction errors ΔO are shown in the following formula:

$$\{ \begin{matrix}Δ P = {(}^{W} {T}_{T}^{r} - {(}^{W} {T}_{T}^{i} ) \cdot {[ 0001 ]}^{T} \\ Δ O = {(}^{W} {T}_{T}^{r} - {(}^{W} {T}_{T}^{i} ) \cdot {[ 0010 ]}^{T}\end{matrix}$$

where ^{W}T_{T}^{t} is an actual kinematic matrix of a tool relative to a workpiece, and ^{w}T_{T}ⁱ is an ideal kinematic matrix of the tool relative to the workpiece.

After the spatial error model of the five-axis computer numerical control machine tool is established, 41 geometric errors and thermal errors may be measured by using devices such as a laser interferometer and a ballbar. For the geometric errors, the error curve may be polynomially fitted to be described as a position function (that is, a geometric error function). For the thermal errors, a constant shape (a geometric portion) of positioning errors is fitted into a polynomial function with a coordinate value as an independent variable, a time-varying slope (a thermal portion) is fitted into a temperature function, and finally, a composite function (that is, a thermal error function) formed by superimposing the constant shape and the time-varying slope is obtained. The geometric error function and the thermal error function are input into the spatial error model to obtain the machining error prediction model, so that machining errors on a tool path of the workpiece can be predicted in real time.

Step 2: Assembly positioning between assembly parts.

In assembly precision prediction and control, determining assembly positioning of a part model is a primary issue. In actual application, the assembly part is first programmed to obtain NC code used to control the machine tool. Then, machining errors of the assembly surface are predicted based on the above-mentioned machining error prediction model, and finally, the machining errors are superimposed on a theoretical plane to obtain the predicted machining surface.

In a product design phase, the part model is assembled theoretically in CAD software according to an assembly constraint condition. When the part model is exported in the form of STEP for real assembly simulation, only a final assembly state (that is, only spatial position information) of the part is reserved, and the assembly constraint information is missing. Specifically, in this embodiment of the present application, the assembly constraint may be converted into geometric information, to constraint a spatial position state of each part in the form of a transition matrix.

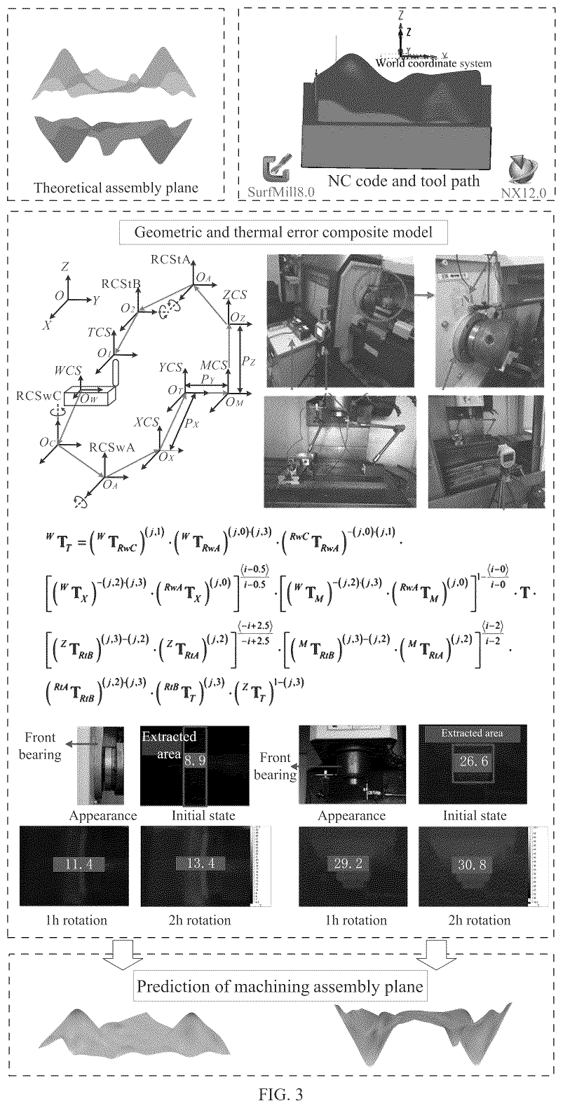

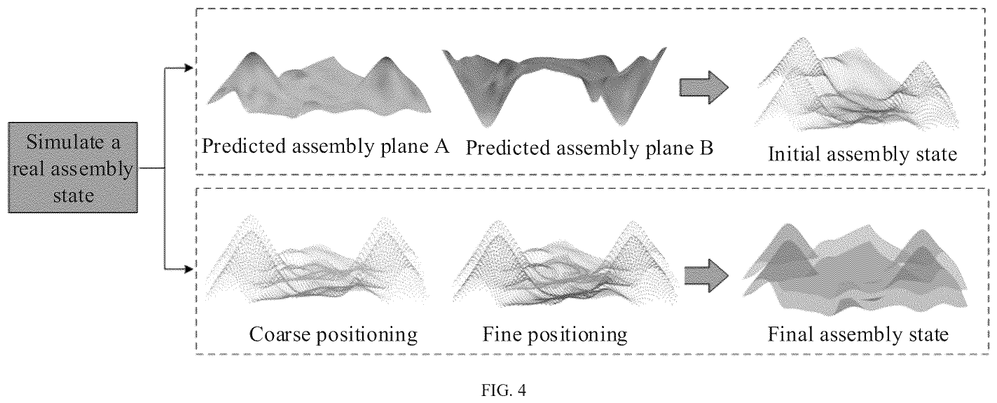

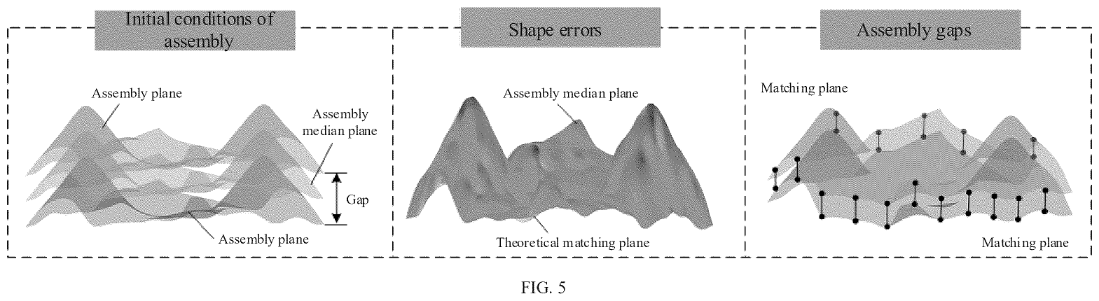

Assembly positioning of the part may be divided into two processes: coarse positioning and fine positioning. During coarse positioning, an initial position of a curved surface is determined by using an ideal model and a positioning reference. During fine processing, a relative position between curved surfaces is optimized based on curved surface information. The above-mentioned steps may refer to FIG. 3 and FIG. 4. It should be noted that FIG. 3 to FIG. 8 involved herein merely show related steps and procedures as a schematic, and specific content and detailed values of formulas, charts, and coordinates in each diagram do not need to be described one by one. FIG. 3 illustrates a process for forming a predicted machining surface after a theoretical assembly plane based on the NC code is superimposed with machining errors. FIG. 4 illustrates an assembly process for simulating a real assembly state and an assembly method based on coarse positioning and fine positioning.

Step 3: Prediction of assembly precision based on “shape-gap” indicators (that is, a shape error indicator and an assembly gap error indicator).

An assembly gap between assembly planes is directly related to assembly precision, which is one of important features reflecting product quality and is usually used for assembly precision analysis. However, a complex curved surface product needs to consider both assembly precision and assembly performance. Therefore, in this embodiment, the “shape-gap” dual assembly indicators are used to simultaneously analyze assembly precision and assembly performance of the product, so as to ensure a qualified rate of electromechanical products.

As shown in FIG. 5, the “shape” indicator refers to a curved surface deviation between an assembly median plane and a theoretical assembly plane, which determines assembly precision. The “gap” indicator corresponds to a gap between two assembly planes whose uniformity determines assembly performance. The “shape-gap” dual indicators can effectively improve assembly quality. A calculation formula of the shape errors Eₛₕₐₚₑ is as follows.

$${E}_{shape} ( P , Q ) = min EMD ( P , Q ) = min {\sum }_{i = 1}^{N} {\sum }_{j = 1}^{N} {d}_{ij}$$

A calculation process is as follows: first, an averaging operation is performed on the two assembly planes to obtain the assembly median plane, and the assembly median plane and the theoretical assembly plane are discretized into point cloud coordinates (corresponding points are respectively P and Q, and N is a quantity of points on each plane). Then, coordinates of the assembly median plane and the theoretical assembly plane are normalized. Thereafter, points on the assembly median plane and the theoretical assembly plane are matched using an Earth mover's distance. After matching is completed, minimum values of sums of Euclidean distances (dᵢⱼ represents the Euclidean distance) between the corresponding points are the shape errors.

The “gap” indicator refers to assembly gap errors E_{gap} between two assembly planes, whose uniformity determines assembly performance. In the present application, the assembly gap errors are calculated by using a root mean square error method, with a calculation process as follows:

$${E}_{gap} ( P , Q ) = \sqrt{{\sum }_{i = 1}^{N} \frac{{( {p}_{i} - {q}_{i} )}^{2}}{N}} = \sqrt{{\sum }_{i = 1}^{N} \frac{{( {x}_{i} - {x}_{i}^{*} )}^{2} + {( {y}_{i} - {y}_{i}^{*} )}^{2} + {( {z}_{i} - {z}_{i}^{*} )}^{2}}{N}}$$

where xᵢ, vᵢ, zᵢ is a coordinate value of pᵢ on the assembly median plane, and xᵢ*, yᵢ*, zᵢ* is a coordinate value of di on the theoretical assembly plane.

Step 4: Calculation of an adaptive compensation amount based on “shape-gap” collaboration

In this step, the “shape-gap” indicators are used as optimization objectives to improve product assembly quality by means of collaborated adaptive compensation. A first-processing assembly plane is defined as a plane A, and a second-processing assembly plane is defined as a plane B. A method for calculating adaptive compensation amounts of the two planes is described as follows.

First, an assembly median plane is obtained based on two assembly planes. According to requirements of the “shape” indicator, a tolerance zone is added to the assembly median plane as a constraint condition (first constraint condition) for the adaptive compensation amount. To ensure assembly quality, the adaptive compensation amount of the plane A needs to comprehensively consider the machining errors of the machine tool, machining quality of the plane B, and the first constraint condition. The adaptive compensation amount Δa of the plane A is calculated according to the following formula:

$${A}_{0} + {a}_{0} + Δ a = ( {B}_{0} + {b}_{0} ) \cdot M$$

where A₀ represents coordinate data of A, B₀ represents coordinate data of B, a₀ represents machining errors between the plane A and a corresponding theoretical plane, b₀ represents machining errors between the plane B and a corresponding theoretical plane, and M represents a transition matrix from a coordinate system of the plane A to a coordinate system of the plane B.

After the adaptive compensation amount Δa of the plane A is obtained by using the above-mentioned formula, the compensated assembly curved surface may be calculated based on a mirror method. Thereafter, whether performance of the compensated assembly curved surface A meets the first constraint condition is evaluated. If the performance completely meets the first constraint condition, machining may be started. If there is a point that exceeds a performance tolerance zone, taking b₀=0 at the point, the adaptive compensation amount Δa is recalculated and the plane A is fitted, and machining may be started after the first constraint condition is met. By performing curved surface reconstruction on the plane A based on Aa an assembly plane A₁ can be obtained.

Thereafter, compensation calculation is performed on the plane B. To ensure assembly quality, the adaptive compensation amount of the plane B needs to comprehensively consider predicted machining errors, a predicted compensation amount of the plane A, and a “gap” indicator constraint (that is, a second constraint condition). The adaptive compensation amount Δb of the plane B is calculated according to the following formula:

$${B}_{0} + {b}_{0} + Δ b = {A}_{1} \cdot {M}^{′}$$

where A₁ represents coordinate data of the plane A that meets the first constraint condition after compensation, and M′ represents a transition matrix from the coordinate system of the plane A to the coordinate system of the plane B.

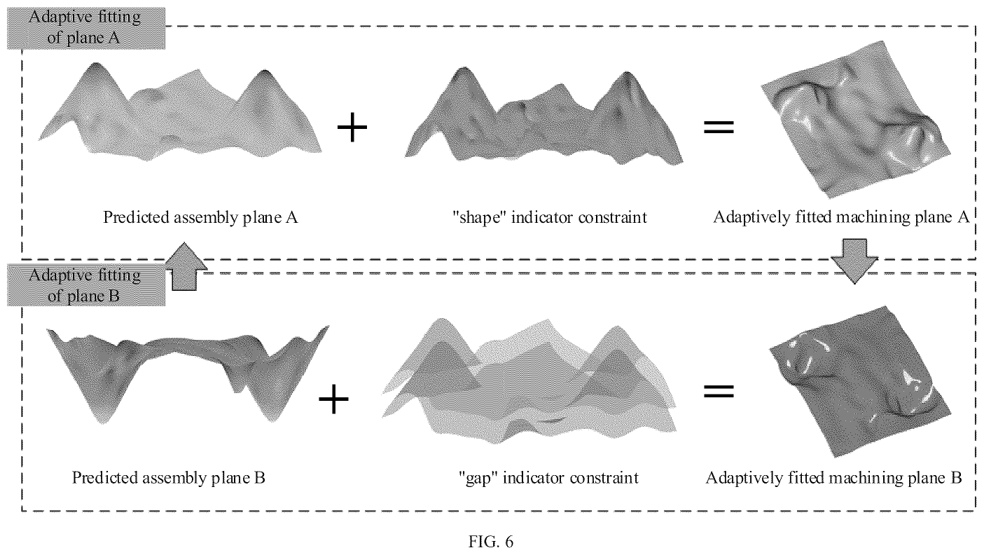

Finally, based on the optimized adaptive compensation amount Δb of the plane B, a plane B1 after compensation machining may be obtained by using a mirror method. The “shape-gap” indicators under real assembly are simulated by using a digital-driven assembly precision analysis model, thereby verifying the validity of a “shape-gap” coordinated adaptive compensation method. The above-mentioned process for calculating adaptive compensation may refer to FIG. 6.

The following describes another specific embodiment of the present application.

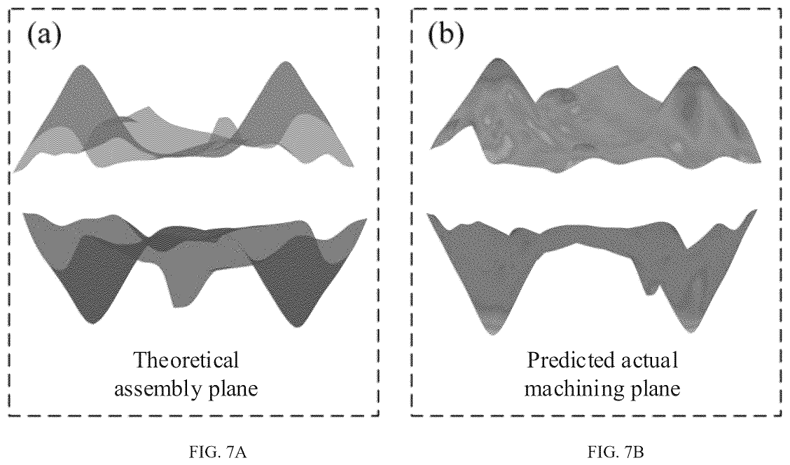

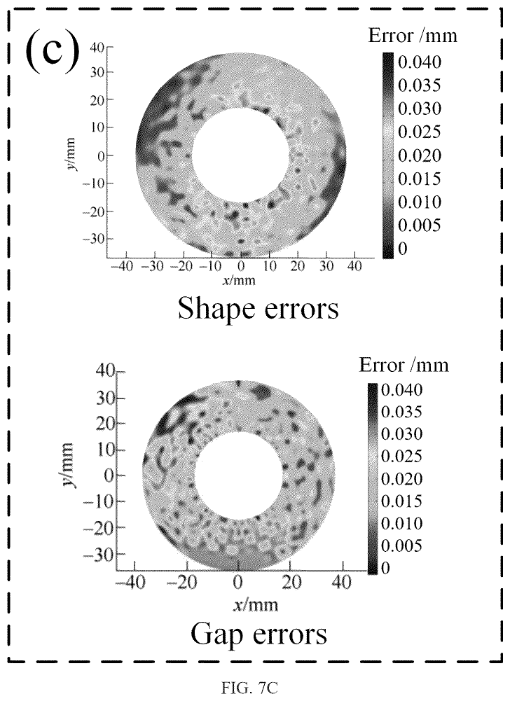

In this embodiment, assembly precision analysis is performed on a complex curved surface assembly part in FIG. 7A. First, a tool path and NC code of the complex curved surface assembly part are obtained by using Surfmill and NX 12.0 software, and geometric errors and thermal errors of a five-axis computer numerical control machine tool are predicted to obtain a real machining curved surface, as shown in FIG. 7B. By constructing mapping parts, and supplementing assembly positioning information, “shape-gap” errors of the assembly part are obtained by means of analysis, as shown in FIG. 7C.

The results show that the “shape” errors between the median plane of the complex curved surface assembly part and a theoretical assembly plane reach 10%, and a number of assembly gaps between upper and lower assembly planes exceed a theoretical value and the assembly gaps are not uniform, which needs to be adaptively compensated to ensure assembly quality. Compared with actual shape measurement, the prediction method has prediction precision of more than 90%.

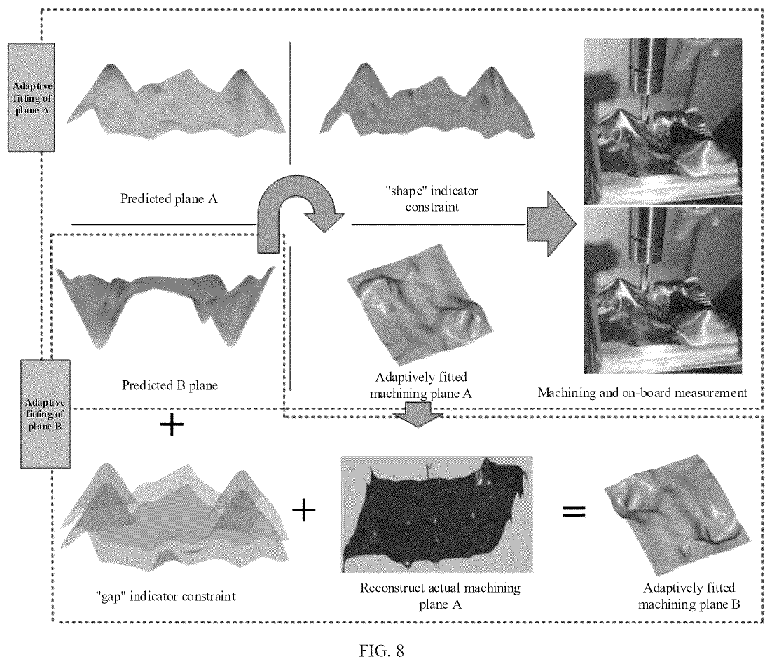

As shown in FIG. 8, based on an assembly quality analysis result, a coordinated adaptive compensation pre-experiment is further performed on a complex curved surface assembly part. First, based on predicted machining errors of the machine tool, machining quality of assembly planes and a “shape” indicator constraint, an adaptive compensation amount of a first-processing assembly plane is calculated to obtain the compensated machining plane A. Then, based on a “gap” indicator constraint and the compensated plane A, an adaptive compensation amount of a plane B is calculated. Finally, the coordinated adaptive fitting between A and B is achieved, and assembly precision is improved by 32% after adaptive fitting.

In conclusion, this embodiment of the present application provides the quality prediction and “shape-gap” coordinated adaptive compensation method for complex curved surface assembly, which has the following basic steps: first, the geometric error model and the thermal error model of the machine tool are established, then the real assembly state is simulated based on the “coarse positioning-precise positioning” method, and then the “shape-gap” dual-indicator system is constructed to evaluate the assembly quality of the complex curved surface, that is, the assembly median plane is established and the shape errors and the assembly gap between the assembly planes to predict assembly quality, and finally, the adaptive compensation amount of each assembly part is coordinately calculated based on an optimal assembly precision objective, to perform real-time compensation on each assembly plane. In this way, compared with the prior art, this embodiment can achieve the following beneficial effects: in the solution for determining the assembly quality of the complex curved surface based on the shape errors and the assembly gap described above, the assembly median plane is established and the shape errors and the assembly gap between the assembly planes are calculated, which improves prediction accuracy of the assembly quality. The “shape-gap” dual-indicator system is further used to evaluate the assembly quality. Using optimal “shape-gap” assembly performance as the objective, the coordinated adaptive compensation amounts of the assembly planes are calculated based on a constraint relation between the assembly planes, and the assembly quality and assembly performance can be greatly improved after compensation.

It should be noted that in the technical solution of the present application, collection, gathering, update, analysis, processing, use, transmission, storage, or other aspects of user personal information involved are in compliance with relevant laws and regulations, are used for legitimate purposes, and do not violate public order and good customs. Necessary measures are taken on user personal information to prevent illegal access to user personal information data, and safeguard user personal information security, network security and national security.

For ease of description, the above-mentioned method embodiments are described as a series of action combinations. However, those skilled in the art should know that the present application is not limited by the described action sequence, and some steps may be performed in other sequences or performed simultaneously. In addition, those skilled in the art should also understand that the embodiments described in the specification are all preferred embodiments, and actions and modules involved may be unnecessary to implement the present application.

To better implement the above-mentioned solutions provided by the embodiments of the present application, the following further provides a related apparatus for implementing the above-mentioned solutions.

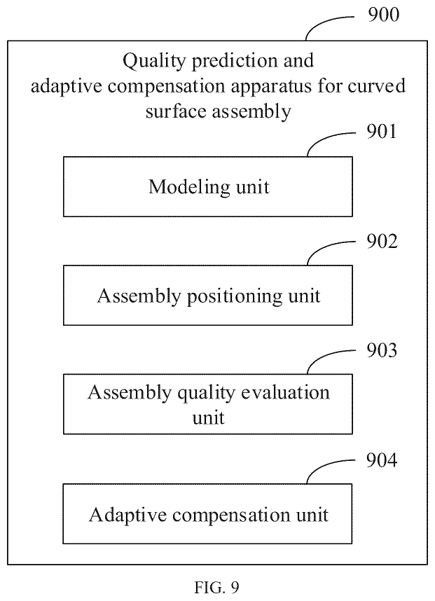

Referring to FIG. 9, a quality prediction and adaptive compensation apparatus 900 for curved surface assembly provided by an embodiment of the present application may include: a modeling unit 901, an assembly positioning unit 902, an assembly quality evaluation unit 903, and an adaptive compensation unit 904.

The modeling unit 901 may be configured to establish a spatial error model of a machine tool, fit measured real geometric error data of the machine tool to form a geometric error function, fit measured real thermal error data of the machine tool to form a thermal error function, and input the geometric error function and the thermal error function into the spatial error model, to obtain a machining error prediction model of the machine tool. The assembly positioning unit 902 may be configured to obtain machining errors of an assembly surface of a part by using the machining error prediction model, superimpose the obtained machining errors on a theoretical plane of the assembly surface, to obtain a predicted machining surface, determine an initial assembly position of the predicted machining surface, and optimize a relative position between curved surfaces of the predicted machining surface based on predetermined curved surface information of the assembly surface, to implement assembly positioning of the part. The assembly quality evaluation unit 903 may be configured to calculate, according to an assembly median plane determined based on the assembly surface, shape errors and assembly gap errors of the assembly surface for the part whose assembly positioning is implemented, and predict curved surface assembly quality of the part by using the shape errors and the assembly gap errors. The adaptive compensation unit 904 may be configured to calculate an adaptive compensation amount of each assembly plane of the assembly surface based on the shape errors, the assembly gap errors, and the machining errors, when the curved surface assembly quality does not meet a preset assembly quality requirement, and compensate the corresponding assembly plane by using the adaptive compensation amount.

In this embodiment of the present application, the modeling unit 901 may be further configured to: fit geometric data in the real thermal error data into a polynomial function with a coordinate value as an independent variable, fit thermal data in the real thermal error data into a time-varying slope function with temperature as an independent variable, and superimpose the polynomial function and the time-varying slope function to form the thermal error function.

In a preferred solution, the assembly positioning unit 902 may be further configured to: obtain assembly constraint information of a real assembly scenario after the obtaining a predicted machining surface, converting the assembly constraint information into geometric information in the form of a transition matrix, and combining the geometric information with the predicted machining surface, to constrain the predicted machining surface.

Preferably, the assembly quality evaluation unit 903 may be further configured to: perform an averaging operation on two assembly planes of the assembly surface to obtain the assembly median plane, discretize the assembly median plane and the two assembly planes to form a plurality of point cloud coordinates, and normalize the point cloud coordinates; match the point cloud coordinates of the assembly median plane and the two assembly planes by using an Earth mover's distance; and determine, after the matching is completed, minimum values of sums of Euclidean distances between the points on the assembly median plane and corresponding points on the two assembly planes as the shape errors.

Optionally, the assembly quality evaluation unit 903 may be further configured to: perform an averaging operation on two assembly planes of the assembly surface to obtain the assembly median plane, discretize the assembly median plane and the two assembly planes to form a plurality of point cloud coordinates, and normalize the point cloud coordinates; match the point cloud coordinates of the assembly median plane and the two assembly planes by using an Earth mover's distance; and determine, after the matching is completed, root mean square errors of coordinates of the points on the assembly median plane and corresponding points on the two assembly planes as the assembly gap errors.

In a specific application, the assembly planes include a first-processing assembly plane and a second-processing assembly plane. The adaptive compensation unit 904 may be further configured to calculate an adaptive compensation amount Δa of the first-processing assembly plane by using the following formula:

$${A}_{0} + {a}_{0} + Δ a = ( {B}_{0} + {b}_{0} ) \cdot M$$

where A₀ represents coordinate data of the first-processing assembly plane, B₀ represents coordinate data of the second-processing assembly plane, a₀, represents machining errors between the first-processing assembly plane and a corresponding theoretical plane, b₀ represents machining errors between the second-processing assembly plane and a corresponding theoretical plane, and M represents a transition matrix from a coordinate system of the second-processing assembly plane to a coordinate system of the first-processing assembly plane. The adaptive compensation unit 904 may be further configured to: determine, after the first-processing assembly plane is compensated by using the adaptive compensation amount Δa, whether the compensated first-processing assembly plane meets a first constraint condition that is determined based on the shape errors: if yes, perform a machining operation; and otherwise, set b₀ of a point that does not meet the first constraint condition to zero, and then recalculate the adaptive compensation amount Δa, until the compensated first-processing assembly plane meets the first constraint condition, where the first constraint condition is a tolerance zone added to the assembly median plane according to the shape errors.

In an optional technical solution, the adaptive compensation unit 904 may be further configured to calculate an adaptive compensation amount Δb of the second-processing assembly plane according to the following formula:

$${B}_{0} + {b}_{0} + Δ b = {A}_{1} \cdot {M}^{′}$$

where A₁ represents coordinate data of the compensated first-processing assembly plane that meets a first constraint condition, and M′ represents a transition matrix from a coordinate system of the first-processing assembly plane to a coordinate system of the second-processing assembly plane. The adaptive compensation unit 904 may be further configured to: determine, after the second-processing assembly plane is compensated by using the adaptive compensation amount Δb, whether the compensated second-processing assembly plane meets a second constraint condition that is determined based on the assembly gap errors: if yes, perform a machining operation; and otherwise, recalculate the adaptive compensation amount Δb, until the compensated second-processing assembly plane meets a second constraint condition.

According to the technical solution provided by this embodiment of the present application, curved surface assembly quality is comprehensively evaluated from two aspects: shape error and assembly gap error, and the adaptive compensation amount of each assembly plane is accurately calculated from the two aspects, thereby greatly improving assembly quality and assembly performance of products.

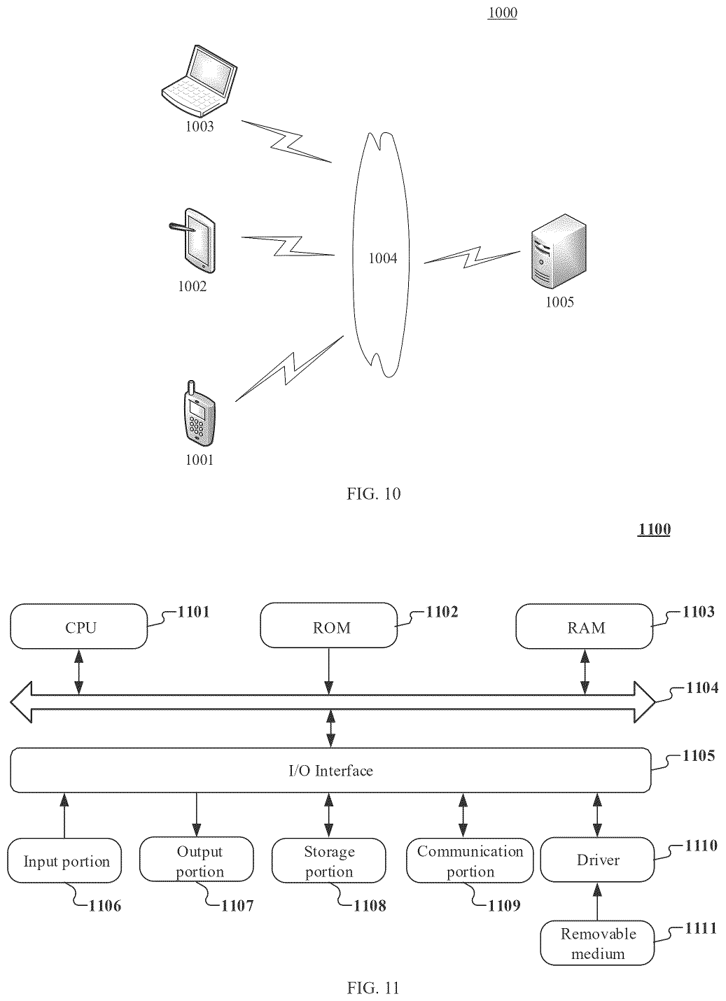

FIG. 10 illustrates an exemplary system architecture 1000 to which a quality prediction and adaptive compensation method for curved surface assembly and a quality prediction and adaptive compensation apparatus for curved surface assembly according to embodiments of the present application can be applied.

As shown in FIG. 10, the system architecture 1000 may include terminal devices 1001, 1002, and 1003, and a network 1004 and a server 1005 (the architecture is merely an example, and components included in the specific architecture may be adjusted according to specific circumstances of the application). The network 1004 is used as a medium for providing a communication link between the terminal devices 1001, 1002, 1003 and the server 1005. The network 1004 may include various connection types, such as wired, wireless communication links, or optical fiber cables.

The user may use the terminal devices 1001, 1002, and 1003 to interact with the server 1005 through the network 1004, to receive or transmit messages, etc. Various client applications may be installed on the terminal devices 1001, 1002, and 1003, such as an assembly quality evaluation application (only an example).

The terminal devices 1001, 1002, and 1003 may be various electronic devices with display screens and supporting web browsing, including but not limited to smartphones, tablet computers, laptop computers, desktop computers, or the like.

The server 1005 may be a server that provides various services, for example, a background server (only as an example) that provides support for an assembly quality evaluation application operated by a user using the terminal devices 1001, 1002, and 1003. The background server may process a received quality evaluation request, and feed a processing result (for example, a calculated assembly quality score, only an example) back to the terminal devices 1001, 1002, and 1003.

It should be noted that the quality prediction and adaptive compensation method for curved surface assembly provided by this embodiment of the present application may be performed by the server 1005. Accordingly, the quality prediction and adaptive compensation apparatus for curved surface assembly may be disposed in the server 1005.

It should be understood that quantities of the terminal devices, networks, and servers in FIG. 10 are merely schematic. According to implementation requirements, there may be any quantities of terminal devices, networks, and servers.

The present application further provides an electronic device. The electronic device provided by an embodiment of the present application includes one or more processors; and a storage apparatus configured to store one or more programs, where the one or more programs, when executed by the one or more processors, cause the one or more processors to implement a quality prediction and adaptive compensation method for curved surface assembly provided by the present application.

Reference is made to FIG. 11 below, which is a schematic structural diagram of a computer system 1100 of an electronic device suitable for implementing embodiments of the present application. The electronic device shown in FIG. 11 is merely an example, and should not impose any limitation on the function and the scope of use of the embodiments of the present application.

As shown in FIG. 11, the computer system 1100 includes a central processing unit (CPU) 1101 that may perform a variety of appropriate actions and processing according to programs stored in a read-only memory (ROM) 1102 or programs loaded from a storage portion 1108 into a random access memory (RAM) 1103. The RAM 1103 further stores various programs and data required for operations of the computer system 1100. The CPU 1101, the ROM 1102, and the RAM 1103 are connected to each other through a bus 1104. An input/output (I/O) interface 1105 is also connected to the bus 1104.

The following components are connected to the I/O interface 1105: an input portion 1106 including a keyboard, a mouse, or the like; an output portion 1107 including a cathode ray tube (CRT), a liquid crystal display (LCD), a speaker, or the like; a storage portion 1108 including a hard disk or the like; and a communication portion 1109 including a network interface card such as a LAN card and a modem. The communication portion 1109 performs communication processing via a network such as the Internet. A driver 1110 is also connected to the I/O interface 1105 as required. A removable medium 1111 such as a magnetic disk, an optical disc, a magneto-optical disc, or a semiconductor memory, is installed on the driver 1110 as required, such that a computer program read therefrom is installed into the storage portion 1108 as required.

In particular, according to the embodiments disclosed in the present application, the process described above in a main step diagram may be implemented as a computer software program. For example, an embodiment of the present application includes a computer program product that includes a computer program carried on a computer-readable medium, where the computer program contains program code for performing the method shown in the main step diagram. In the above-mentioned embodiment, the computer program may be downloaded and installed from a network through the communication portion 1109, and/or installed from the removable medium 1111. When the computer program is executed by the central processing unit 1101, the above-mentioned functions defined in the system of the present application are executed.

It should be noted that the computer-readable medium shown in the present application may be a computer-readable signal medium, a computer-readable storage medium, or any combination thereof. The computer-readable storage medium may be, but is not limited to, for example, an electrical, magnetic, optical, electromagnetic, infrared, or semiconductor system, apparatus, or device, or any combination thereof. A more specific example of the computer-readable storage medium may include, but is not limited to, an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present application, the computer-readable storage medium may be any tangible medium that includes or stores a program, and the program may be used by or in combination with an instruction execution system, apparatus, or component. In the present application, the computer-readable signal medium may include a data signal propagated in a baseband or as a portion of carriers, and computer-readable program code is carried therein. Such a propagated data signal may be in a variety of forms, including but not limited to an electromagnetic signal, an optical signal, or any suitable combination thereof. The computer-readable signal medium may further be any computer-readable medium other than a computer-readable storage medium, and the computer-readable medium may send, propagate, or transmit a program that is used by or in combination with an instruction execution system, apparatus, or component. The program code contained in the computer-readable medium may be transmitted by using any suitable medium, including but not limited to: wireless, wire, optical cable, RF, etc., or any suitable combination thereof.

Flowcharts and block diagrams in the accompanying drawings illustrate possible architectures, functions, and operations of systems, methods, and computer program products according to various embodiments of the present application. In this regard, each block in the flowcharts or the block diagrams may represent a module, a program segment, or a portion of code. The module, the program segment, or the portion of code includes one or more executable instructions for implementing a specified logical function. It should also be noted that in some alternative implementations, functions marked in the block may also occur in an order different from those marked in the accompanying drawings. For example, two blocks shown in succession may actually be performed substantially in parallel, or they may sometimes be performed in the reverse order, depending on the functions involved. It should also be noted that each block in the block diagram or the flowchart, and a combination of the blocks in the block diagram or the flowchart may be implemented by a dedicated hardware-based system that executes specified functions or operations, or may be implemented by a combination of dedicated hardware and computer instructions.

The units involved in the embodiments of the present application may be implemented by software, or by hardware. The described unit may alternatively be disposed in a processor. For example, the processor may be described as: a processor including a modeling unit, an assembly positioning unit, an assembly quality evaluation unit, and an adaptive compensation unit. Names of these units do not constitute a limitation on the units themselves in some cases, for example, the modeling unit may alternatively be described as “a unit for providing a machining error prediction model for the assembly positioning unit”.

In another aspect, the present application further provides a computer-readable medium, where the computer-readable medium may be contained in the device described in the above-mentioned embodiment, or may exist separately and not be assembled into the device. The above-mentioned computer-readable medium carries one or more programs. The one or more programs, when executed by the device, causes the device to perform the following steps: establishing a spatial error model of a machine tool; fitting measured real geometric error data of the machine tool to form a geometric error function; fitting measured real thermal error data of the machine tool to form a thermal error function; inputting the geometric error function and the thermal error function into the spatial error model, to obtain a machining error prediction model of the machine tool; obtaining machining errors of an assembly surface of a part by using the machining error prediction model, and superimposing the obtained machining errors on a theoretical plane of the assembly surface, to obtain a predicted machining surface; determining an initial assembly position of the predicted machining surface, and optimizing a relative position between curved surfaces of the predicted machining surface based on predetermined curved surface information of the assembly surface, to implement assembly positioning of the part; calculating, according to an assembly median plane determined based on the assembly surface, shape errors and assembly gap errors of the assembly surface for the part whose assembly positioning is implemented, and predict curved surface assembly quality of the part by using the shape errors and the assembly gap errors; and calculating an adaptive compensation amount of each assembly plane of the assembly surface based on the shape errors, the assembly gap errors, and the machining errors, when the curved surface assembly quality does not meet a preset assembly quality requirement, and compensating the corresponding assembly plane using adaptive compensation amount.

In the technical solutions of the embodiments of the present application, the spatial error model of the machine tool is first established, and the geometric error function and the thermal error function that are determined based on the real error data are input into the spatial error model to obtain the machining error prediction model of the machine tool. Then, the machining errors of the assembly surface of the part are obtained by using the machining error prediction model, and the obtained machining errors are superimposed on the theoretical plane of the assembly surface to obtain the predicted machining surface, and assembly positioning of the part is implemented by a coarse positioning step and a fine positioning step. Then, the assembly median plane of the assembly surface is determined, the shape errors and the assembly gap errors of the assembly surface are calculated, and the curved surface assembly quality of the part is predicted by using the calculated shape errors and assembly gap errors. When the curved surface assembly quality does not meet the assembly quality requirement, the adaptive compensation amount of each assembly plane is calculated based on the shape errors, the assembly gap errors, and the machining errors determined by the above-mentioned machining error prediction model, and finally, the corresponding assembly plane is compensated by using the calculated adaptive compensation amount. Through the above-mentioned steps, the curved surface assembly quality is comprehensively evaluated from two aspects: shape error and assembly gap error, and the adaptive compensation amount of each assembly plane is accurately calculated from the two aspects, thereby greatly improving assembly quality and assembly performance of products.

The above-mentioned specific implementations do not constitute a limitation on the protection scope of the present application. Those skilled in the art should understand that various modifications, combinations, sub-combinations and substitutions may occur depending on design requirements and other factors. Any modification, equivalent replacement and improvement made within the spirit and principles of the present application shall be included in the protection scope of the present application.

What is claimed is:

1. A quality prediction and adaptive compensation method for curved surface assembly, comprising:
establishing a spatial error model of a machine tool, fitting measured real geometric error data of the machine tool to form a geometric error function, fitting measured real thermal error data of the machine tool to form a thermal error function, and inputting the geometric error function and the thermal error function into the spatial error model to obtain a machining error prediction model of the machine tool;
obtaining machining errors of an assembly surface of a part by using the machining error prediction model, superimposing the machining errors on a theoretical plane of the assembly surface to obtain a predicted machining surface, determining an initial assembly position of the predicted machining surface, and optimizing a relative position between curved surfaces of the predicted machining surface based on pre-determined curved surface information of the assembly surface, to implement assembly positioning of the part;
calculating, according to an assembly median plane determined based on the assembly surface, shape errors and assembly gap errors for the part, wherein the assembly positioning of the part is implemented, and predicting curved surface assembly quality of the part by using the shape errors and the assembly gap errors; and
calculating an adaptive compensation amount of each assembly plane of the assembly surface based on the shape errors, the assembly gap errors and the machining errors when the curved surface assembly quality does not meet a preset assembly quality requirement, and compensating a corresponding assembly plane by using the adaptive compensation amount.

2. The quality prediction and adaptive compensation method according to claim 1, wherein fitting the measured real thermal error data of the machine tool to form the thermal error function comprises: fitting geometric data in the measured real thermal error data into a polynomial function with a coordinate value as a first independent variable, fitting thermal data in the measured real thermal error data into a time-varying slope function with a temperature as a second independent variable, and superimposing the polynomial function and the time-varying slope function to form the thermal error function.

3. The quality prediction and adaptive compensation method according to claim 1, further comprising:
obtaining assembly constraint information of a real assembly scenario after obtaining the predicted machining surface, converting the assembly constraint information into geometric information in a form of a transition matrix, and combining the geometric information with the predicted machining surface, to constrain the predicted machining surface.

4. The quality prediction and adaptive compensation method according to claim 1, wherein calculating the shape errors comprises:
performing an averaging operation on two assembly planes of the assembly surface to obtain the assembly median plane, discretizing the assembly median plane and the two assembly planes to form a plurality of point cloud coordinates, and normalizing the plurality of point cloud coordinates; and
matching the plurality of point cloud coordinates of the assembly median plane and the two assembly planes by using an Earth mover's distance; and determining, after the matching is completed, minimum values of sums of Euclidean distances between points on the assembly median plane and corresponding points on the two assembly planes as the shape errors.

5. The quality prediction and adaptive compensation method according to claim 1, wherein calculating the assembly gap errors comprises:
performing an averaging operation on two assembly planes of the assembly surface to obtain the assembly median plane, discretizing the assembly median plane and the two assembly planes to form a plurality of point cloud coordinates, and normalizing the plurality of point cloud coordinates; and
matching the plurality of point cloud coordinates of the assembly median plane and the two assembly planes by using an Earth mover's distance; and after the matching is completed, determining root mean square errors of coordinates of points on the assembly median plane and corresponding points on the two assembly planes as the assembly gap errors.

6. The quality prediction and adaptive compensation method according to claim 1, wherein the assembly planes comprise a first-processing assembly plane and a second-processing assembly plane; and an adaptive compensation amount Δa of the first-processing assembly plane is calculated according to the following formula:
$${A}_{0} + {a}_{0} + Δ a = ( {B}_{0} + {b}_{0} ) \cdot M$$
wherein A₀ represents first coordinate data of the first-processing assembly plane, B₀ represents coordinate data of the second-processing assembly plane, a₀ represents machining errors between the first-processing assembly plane and a first corresponding theoretical plane, b₀ represents machining errors between the second-processing assembly plane and a second corresponding theoretical plane, and M represents a first transition matrix from a coordinate system of the second-processing assembly plane to a coordinate system of the first-processing assembly plane; and
the quality prediction and adaptive compensation method further comprises: determining, after the first-processing assembly plane is compensated by using the adaptive compensation amount Δa to obtain a compensated first-processing assembly plane, whether the compensated first-processing assembly plane meets a first constraint condition, wherein the first constraint condition is determined based on the shape errors: when the compensated first-processing assembly plane meets the first constraint condition, performing a machining operation; and when the compensated first-processing assembly plane does not meet the first constraint condition, setting b₀ of a point to zero, wherein the point does not meet the first constraint condition, and then recalculating the adaptive compensation amount Δa, until the compensated first-processing assembly plane meets the first constraint condition, wherein the first constraint condition is a tolerance zone added to the assembly median plane according to the shape errors.

7. The quality prediction and adaptive compensation method according to claim 6, wherein an adaptive compensation amount Δb of the second-processing assembly plane is calculated according to the following formula:
$${B}_{0} + {b}_{0} + Δ b = {A}_{1} \cdot {M}^{′}$$
wherein A₁ represents second coordinate data of the first-processing assembly plane, wherein the second coordinate data of the first-processing assembly plane meets the first constraint condition after compensation, and M′ represents a second transition matrix from the coordinate system of the first-processing assembly plane to the coordinate system of the second-processing assembly plane; and
the quality prediction and adaptive compensation method further comprises: determining, after the second-processing assembly plane is compensated by using the adaptive compensation amount Δb to obtain a compensated second-processing assembly plane, whether the compensated second-processing assembly plane meets a second constraint condition, wherein the second constraint condition is determined based on the assembly gap errors: when the compensated second-processing assembly plane meets the second constraint condition, performing the machining operation; and when the compensated second-processing assembly plane does not meet the second constraint condition, recalculating the adaptive compensation amount Δb, until the compensated second-processing assembly plane meets the second constraint condition.

8. A quality prediction and adaptive compensation apparatus for curved surface assembly, comprising:
a modeling unit configured to: establish a spatial error model of a machine tool, fit measured real geometric error data of the machine tool to form a geometric error function, fit measured real thermal error data of the machine tool to form a thermal error function, and input the geometric error function and the thermal error function into the spatial error model to obtain a machining error prediction model of the machine tool;
an assembly positioning unit configured to: obtain machining errors of an assembly surface of a part by using the machining error prediction model, superimpose the machining errors on a theoretical plane of the assembly surface to obtain a predicted machining surface, determine an initial assembly position of the predicted machining surface, and optimize a relative position between curved surfaces of the predicted machining surface based on pre-determined curved surface information of the assembly surface, to implement assembly positioning of the part;
an assembly quality evaluation unit configured to: calculate, according to an assembly median plane determined based on the assembly surface, shape errors and assembly gap errors for the part, wherein the assembly positioning of the part is implemented, and predict curved surface assembly quality of the part by using the shape errors and the assembly gap errors; and
an adaptive compensation unit configured to: calculate an adaptive compensation amount of each assembly plane of the assembly surface based on the shape errors, the assembly gap errors and the machining errors when the curved surface assembly quality does not meet a preset assembly quality requirement, and compensate a corresponding assembly plane by using the adaptive compensation amount.

9. An electronic device, comprising:
one or more processors; and
a storage apparatus configured to store one or more programs, wherein
the one or more programs, when executed by the one or more processors, allow the one or more processors to implement the quality prediction and adaptive compensation method according to claim 1.

10. A computer-readable storage medium, wherein a computer program is stored on the computer-readable storage medium, and
the computer program, when executed by a processor, implements the quality prediction and adaptive compensation method according to claim 1.

11. The electronic device according to claim 9, wherein in the quality prediction and adaptive compensation method, fitting the measured real thermal error data of the machine tool to form the thermal error function comprises: fitting geometric data in the measured real thermal error data into a polynomial function with a coordinate value as a first independent variable, fitting thermal data in the measured real thermal error data into a time-varying slope function with a temperature as a second independent variable, and superimposing the polynomial function and the time-varying slope function to form the thermal error function.

12. The electronic device according to claim 9, wherein the quality prediction and adaptive compensation method further comprises:
obtaining assembly constraint information of a real assembly scenario after obtaining the predicted machining surface, converting the assembly constraint information into geometric information in a form of a transition matrix, and combining the geometric information with the predicted machining surface, to constrain the predicted machining surface.

13. The electronic device according to claim 9, wherein in the quality prediction and adaptive compensation method, calculating the shape errors comprises:
performing an averaging operation on two assembly planes of the assembly surface to obtain the assembly median plane, discretizing the assembly median plane and the two assembly planes to form a plurality of point cloud coordinates, and normalizing the plurality of point cloud coordinates; and
matching the plurality of point cloud coordinates of the assembly median plane and the two assembly planes by using an Earth mover's distance; and determining, after the matching is completed, minimum values of sums of Euclidean distances between points on the assembly median plane and corresponding points on the two assembly planes as the shape errors.

14. The electronic device according to claim 9, wherein in the quality prediction and adaptive compensation method, calculating the assembly gap errors comprises:
performing an averaging operation on two assembly planes of the assembly surface to obtain the assembly median plane, discretizing the assembly median plane and the two assembly planes to form a plurality of point cloud coordinates, and normalizing the plurality of point cloud coordinates; and
matching the plurality of point cloud coordinates of the assembly median plane and the two assembly planes by using an Earth mover's distance; and after the matching is completed, determining root mean square errors of coordinates of points on the assembly median plane and corresponding points on the two assembly planes as the assembly gap errors.

15. The electronic device according to claim 9, wherein in the quality prediction and adaptive compensation method, the assembly planes comprise a first-processing assembly plane and a second-processing assembly plane; and an adaptive compensation amount Δa of the first-processing assembly plane is calculated according to the following formula:
$${A}_{0} + {a}_{0} + Δ a = ( {B}_{0} + {b}_{0} ) \cdot M$$
wherein A₀ represents first coordinate data of the first-processing assembly plane, B₀ represents coordinate data of the second-processing assembly plane, a₀, represents machining errors between the first-processing assembly plane and a first corresponding theoretical plane, b₀ represents machining errors between the second-processing assembly plane and a second corresponding theoretical plane, and M represents a first transition matrix from a coordinate system of the second-processing assembly plane to a coordinate system of the first-processing assembly plane; and
the quality prediction and adaptive compensation method further comprises: determining, after the first-processing assembly plane is compensated by using the adaptive compensation amount Δa to obtain a compensated first-processing assembly plane, whether the compensated first-processing assembly plane meets a first constraint condition, wherein the first constraint condition is determined based on the shape errors: when the compensated first-processing assembly plane meets the first constraint condition, performing a machining operation; and when the compensated first-processing assembly plane does not meet the first constraint condition, setting b₀ of a point to zero, wherein the point does not meet the first constraint condition, and then recalculating the adaptive compensation amount Δa, until the compensated first-processing assembly plane meets the first constraint condition, wherein the first constraint condition is a tolerance zone added to the assembly median plane according to the shape errors.

16. The electronic device according to claim 15, wherein in the quality prediction and adaptive compensation method, an adaptive compensation amount Δb of the second-processing assembly plane is calculated according to the following formula:
$${B}_{0} + {b}_{0} + Δ b = {A}_{1} \cdot {M}^{′}$$
wherein A₁ represents second coordinate data of the first-processing assembly plane, wherein the second coordinate data of the first-processing assembly plane meets the first constraint condition after compensation, and M′ represents a second transition matrix from the coordinate system of the first-processing assembly plane to the coordinate system of the second-processing assembly plane; and
the quality prediction and adaptive compensation method further comprises: determining, after the second-processing assembly plane is compensated by using the adaptive compensation amount Δb to obtain a compensated second-processing assembly plane, whether the compensated second-processing assembly plane meets a second constraint condition, wherein the second constraint condition is determined based on the assembly gap errors: when the compensated second-processing assembly plane meets the second constraint condition, performing the machining operation; and when the compensated second-processing assembly plane does not meet the second constraint condition, recalculating the adaptive compensation amount Δb, until the compensated second-processing assembly plane meets the second constraint condition.

17. The computer-readable storage medium according to claim 10, wherein in the quality prediction and adaptive compensation method, fitting the measured real thermal error data of the machine tool to form the thermal error function comprises: fitting geometric data in the measured real thermal error data into a polynomial function with a coordinate value as a first independent variable, fitting thermal data in the measured real thermal error data into a time-varying slope function with a temperature as a second independent variable, and superimposing the polynomial function and the time-varying slope function to form the thermal error function.

18. The computer-readable storage medium according to claim 10, wherein the quality prediction and adaptive compensation method further comprises:
obtaining assembly constraint information of a real assembly scenario after obtaining the predicted machining surface, converting the assembly constraint information into geometric information in a form of a transition matrix, and combining the geometric information with the predicted machining surface, to constrain the predicted machining surface.

19. The computer-readable storage medium according to claim 10, wherein in the quality prediction and adaptive compensation method, calculating the shape errors comprises:
performing an averaging operation on two assembly planes of the assembly surface to obtain the assembly median plane, discretizing the assembly median plane and the two assembly planes to form a plurality of point cloud coordinates, and normalizing the plurality of point cloud coordinates; and
matching the plurality of point cloud coordinates of the assembly median plane and the two assembly planes by using an Earth mover's distance; and determining, after the matching is completed, minimum values of sums of Euclidean distances between points on the assembly median plane and corresponding points on the two assembly planes as the shape errors.

20. The computer-readable storage medium according to claim 10, wherein in the quality prediction and adaptive compensation method, calculating the assembly gap errors comprises:
performing an averaging operation on two assembly planes of the assembly surface to obtain the assembly median plane, discretizing the assembly median plane and the two assembly planes to form a plurality of point cloud coordinates, and normalizing the plurality of point cloud coordinates; and
matching the plurality of point cloud coordinates of the assembly median plane and the two assembly planes by using an Earth mover's distance; and after the matching is completed, determining root mean square errors of coordinates of points on the assembly median plane and corresponding points on the two assembly planes as the assembly gap errors.
